(19) United States
(12) Patent Application Publication
(10) Pub. No.: US 2006/0261924 A1
(43) Pub. Date: Nov. 23, 2006

(54) Method of forming passive electronic components on a substrate by direct write technique using shaped uniform laser beam

(76) Inventors: Edward J. Swenson, Portland, OR (US); Douglas B. Howe, Portland, OR (US); Stephen R. Johnson, Beaverton, OR (US); Douglas J. Garcia, Beaverton, OR (US)

Correspondence Address: STOEL RIVES LLP, 900 SW FIFTH AVENUE, SUITE 2600, PORTLAND, OR, 97204-1268, US

(21) Appl. No.: 11/437,410

(22) Filed: May 19, 2006

Related U.S. Application Data
(60) Provisional application No. 60/683,267, filed on May 20, 2005.

(51) Int. Cl. H01C 10/00

(52) U.S. Cl. 338/195

(57) ABSTRACT

A method of using a laser to achieve direct patterning of resistive or electrically conductive materials in the fabrication of miniature electronic components entails aligning with a patterned array-carrying major surface a laser beam that has a sufficient spot size and energy distribution to remove selected portions of resistive or conductive material that has been applied to the substrate. The major surface carrying the resistive or conductive material and the laser beam are moved relative to each other such that the laser beam ablates, or otherwise removes, selected portions of the resistive or conductive material. Thus preferred embodiments of the method form an array of multiple, mutually spaced-apart resistive or conductive material regions whose side and end margins have improved dimensional precision.

### RELATED APPLICATION

This application claims benefit of U.S. Provisional Patent Application No. 60/683,267, filed May 20, 2005.

### TECHNICAL FIELD

The present invention relates to the efficient and accurate formation of next-generation, miniature passive electronic components and, more particularly, to a method of forming an array of spaced-apart, dimensionally precise resistive or electrically conductive material regions on a substrate.

### BACKGROUND INFORMATION

Miniature passive electronic circuit components are conventionally fabricated in an array on a substrate. Exemplary types of passive electronic components of interest with regard to the present invention are resistors and capacitors. FIGS. 1A and 1B show an array of resistors in which a substrate 10 includes a first (or upper) major surface 14 and a second (or lower) major surface 16 carrying, respectively, first spaced-apart segmented electrical conductor lines 18 and second spaced-apart segmented electrical conductor lines 20 (end portions of which are shown in dashed lines in FIG. 1B). Segmented electrical conductor lines 18 are in parallel alignment, and segmented electrical conductor lines 20 are in parallel alignment.

Each segmented conductor line 18 is composed of multiple electrode pads 22, adjacent ones of which are separated from each other by a small distance 24 and all of which are aligned along first major surface 14. Except for the two terminal end segmented electrical conductor lines 18, each segmented conductor line 18 is positioned between two neighboring segmented electrical conductor lines 18 and is separated from one of them by a relatively wide space 26 and from the other of them by a relatively narrow space or street 28u. Similarly, each segmented conductor line 20 is composed of multiple electrode pads 30, adjacent ones of which are separated from each other by small distance 24 and all of which are aligned along second major surface 16. Except for the two terminal end segmented electrical conductor lines 20, each segmented conductor line 20 is positioned between two neighboring segmented electrical conductor lines 20 and is separated from one of them by relatively wide space 26 and from the other of them by a street 28l.

The electrical conductor lines are also arranged in spatially aligned pairs of one electrical conductor line 18 on first major surface 14 and one electrical conductor line 20 on second major surface 16. First major surface 14 further includes multiple resistive material regions 32 positioned in spaces 26 between electrode pads 22 of adjacent electrical conductor lines 18, as shown in FIGS. 1A and 1B. Each resistive material region 32 includes opposed side margins 33 and opposed end margins 34. Second major surface 16 may also include electrode pads 30 of or continuous electrical conductor lines 20.

FIGS. 2A and 2B show a substrate of dielectric material 35 that is used in the fabrication of capacitors. Substrate 35 includes a first (or upper) major surface 36 and a second (or lower) major surface 38 between which are internally stacked in plane parallel arrangement multiple substrate layers 44 on which are formed spaced-apart conductive material regions 40. FIGS. 2A and 2B also show exposed side margins 42 of conductive material regions 40. There is no electrical conductor line formed on either of major surfaces 36 and 38.

FIG. 3 is a top view of one of multiple substrate layers 44 that are stacked within substrate 35. Each substrate layer 44 includes multiple spaced-apart conductive material regions 40, each of which includes opposed side margins 46 and opposed end margins 48. Adjacent side margins 46 of adjacent conductive material regions 40 are separated by a relatively narrow street 49, and adjacent end margins 48 of adjacent conductive material regions 40 are separated by a relatively wide street 50. Streets 49 and 50 are positioned generally perpendicular to one another and are spaced apart from adjacent streets by conductive material regions 40.

The substrate arrays shown in FIGS. 1-3 are cut, sometimes called “diced,” to form multiple, discrete passive electronic components. U.S. Pat. No. 7,053,011, entitled LASER-BASED TERMINATION OF PASSIVE ELECTRONIC COMPONENTS and assigned to the assignee of the present application, describes an exemplary preferred method of forming multiple, discrete passive electronic components from a substrate array.

FIG. 4 shows a discrete chip resistor 52 formed by dicing the substrate array of FIGS. 1A and 1B to form multiple, discrete resistive components and then terminating the ends of each component. Chip resistor 52 includes an electrically conductive interconnect 56 that extends between electrical conductor lines 18 and 20 in each spatially aligned pair of them.

FIG. 5 shows a discrete chip capacitor 54 formed by dicing the substrate array of FIGS. 2 and 3 to form multiple, discrete capacitors and then terminating the ends of each capacitor. Chip capacitor 54 in FIG. 5 includes an electrically conductive interconnect 58 that bridges side margins 42 of internal conductive material regions 40. Conductive interconnects 56 and 58 are formed by applying a metal coating (e.g., a silver paste) to a side margin portion 60 of resistor substrate 10 or capacitor substrate 35.

Recent technological advancements in component miniaturization have resulted in the formation of chip resistors 52 and capacitors 54 having respective length and width dimensions of about 0.6 mm×0.3 mm (0201 passive electronic components) and a thickness of between about 90 microns and about 150 microns, as compared to prior art 0402 passive electronic components having respective length and width dimensions of about 1.0 mm×0.5 mm. The small sizes of these next-generation chip resistors 52 and capacitors 54 make accurate and efficient application of the resistive or conductive material exceedingly difficult to achieve.

Most prior art methods of forming resistive or conductive material regions 32 or 40 on respective substrates 10 and 35 entail screen-printing the resistive material onto substrate 10 or conductive material onto substrate 35. Screen-printing is a mechanical process that has inherent size limitations that have been reached. Specifically, screen-printing is becoming ineffective to form next-generation, miniature chip resistors and capacitors because it does not provide sufficient straightness or accuracy of the side margins of next-generation resistive or conductive material regions. Further, screen-printing resistive or conductive material onto a substrate results in the formation of nonuniform resistive or conductive material side margins, and the resulting ragged edges predominate in the next-generation, miniature chip resistors and capacitors. Additionally, repetitive use of a single screen to print multiple substrate plates results in distortion of the screen, and using a new screen to print each plate is prohibitively expensive.

Because they are approaching their physical limits, all of the prior art methods are inadequate for accurately forming next-generation, miniature passive electronic component arrays, including arrays of chip resistors and capacitors. Consequently, a need has arisen for a highly efficient and accurate method of forming arrays of next-generation, miniature passive electronic components.

### SUMMARY OF THE DISCLOSURE

An object of the present invention is, therefore, to provide a method that implements a direct write laser-based technique to form an array of dimensionally precise resistive or conductive material regions whose resistive or conductive material side and end margins have sufficient straightness, accuracy, and dimensional precision to permit their use as next-generation, miniature passive electronic components.

Preferred embodiments of the method may be practiced on a substrate having first and second major surfaces, at least one of which carries on it a patterned array of multiple, mutually spaced-apart regions of unfired or fired resistive or conductive material. Whether the resistive or conductive material is fired or unfired depends on the geometries required and the ability of a dried, unfired material to adhere to a ceramic substrate. Each of the resistive or conductive material regions has opposed side margins and opposed end margins. Each of the end and side margins includes ragged edges that undesirably affect a dimensional precision quality of the array.

Preferred embodiments of the method improve the dimensional precision of the opposed side and end margins by aligning with the patterned array-carrying major surface a laser beam that has a sufficient spot size and energy distribution to remove selected portions of the resistive or conductive material. The major surface carrying the resistive or conductive material and the laser beam are moved relative to each other such that the laser beam ablates, or otherwise removes, the resistive or conductive material that forms the ragged edges of the side and end margins. Thus preferred embodiments of the method form an array of multiple, mutually spaced-apart resistive or conductive material regions whose side and end margins have improved dimensional precision.

Exemplary preferred embodiments of the method are described first with reference to the formation of an array of discrete chip resistors and then with reference to the formation of a substrate layer on which is formed an array of conductive material regions for use in fabricating chip capacitors.

In preferred embodiments relating to the formation of an array of discrete chip resistors, the substrate includes a fired ceramic material (96% alumina for thick film resistors) and the array includes regions of resistive material that form an array of discrete resistors. A preferred method of forming the array entails coating the first and second major surfaces of the fired ceramic substrate with an electrically conductive metal paste. A laser beam is then aligned with and directed relative to the ceramic substrate to remove the electrically conductive metal paste from selected portions of each of the upper and lower major surfaces. The portions of electrically conductive metal paste remaining on the first and second major surfaces of the ceramic substrate form multiple, mutually spaced-apart electrical conductor lines. Use of a laser beam achieves formation of multiple, mutually spaced-apart electrical conductor lines having dimensionally precise side margins.

Next, a resistive material is applied to the first major surface of the ceramic substrate. The resistive material may be screen-printed onto the substrate to form an array of resistive material regions, or the entire first major surface may be coated with the resistive material. Where the substrate includes an array of resistive material regions, the side and end margins of each resistive material region exhibit ragged edges that undesirably affect a dimensional precision quality of the side and end margins.

A preferred method of improving the dimensional precision of the opposed side and end margins of the regions of resistive material entails aligning a laser beam with the major surface that carries the array of resistive material regions whose dimensional precision will be improved. The laser beam has a spot size and an energy distribution sufficient to remove selected portions of the resistive material. The major surface carrying the resistive material regions whose dimensional precision will be improved and the laser beam are moved relative to each other such that the laser beam ablates, or otherwise removes, the ragged edges from the side and end margins of the resistive material regions. Thus preferred embodiments of the method form an array of multiple, mutually spaced-apart resistors whose resistive material regions have side and end margins exhibiting improved dimensional precision.

In preferred embodiments relating to the formation of an array of discrete capacitors, the substrate is an unfired “green” ceramic material on which is formed an array of conductive material regions having opposed side margins and opposed end margins. The array of conductive material regions may, for example, be formed by screen-printing an electrically conductive metallic ink onto the substrate. Each side and end margin includes ragged edges that undesirably affect the dimensional precision of the array. A preferred method of improving the dimensional precision of the opposed side and end margins entails aligning the substrate and a laser beam having a spot size and an energy distribution sufficient to remove selected portions of the screen-printable electrically conductive metallic ink. The substrate layer and the laser beam are then moved relative to each other such that the laser beam ablates, or otherwise removes, the ragged edges from the side and end margins of the conductive material regions. Thus preferred embodiments of the method form a patterned array of multiple, mutually spaced-apart conductive material regions whose side and end margins exhibit improved dimensional precision.

Multiple layers of ceramic material carrying a dimensionally precise array of conductive material regions may be stacked to form a substrate of discrete multi-layer chip capacitors (MLCCs) or a multiplicity of capacitor arrays. The multiple layers of ceramic material are preferably stacked such that the conductive material regions on adjacent layers of ceramic material are spatially aligned. In a preferred embodiment, the spatial alignment of adjacent layers of ceramic material is facilitated by the formation of alignment holes in each ceramic layer.

Although use of a UV laser beam to remove the resistive or conductive material and to form the electrical conductor lines is preferred, the various embodiments described above can be practiced using lasers emitting different wavelengths of light. A laser beam of uniform shape formed by inserting a beam shaping objective lens is preferably used to ablate, or otherwise remove, the resistive or conductive material and to form the electrical conductor lines in the ceramic substrate.

Additional aspects and advantages will be apparent from the following detailed description of preferred embodiments, which proceeds with reference to the accompanying drawings.

### BRIEF DESCRIPTION OF THE DRAWINGS

FIG. 1A is a plan view of a prior art substrate plate carrying an array of resistive material regions positioned between adjacent electrical conductor lines such that, when diced and terminated, multiple discrete chip resistors are formed.

FIG. 1B is an enlarged fragmentary isometric view of several resistive material regions positioned between adjacent electrical conductor lines located in the upper left-hand corner of the prior art substrate plate of FIG. 1A.

FIG. 2A is a fragmentary isometric view showing a side margin of a substrate plate as seen from either one of the front-side or rear-side major surfaces of the substrate plate.

FIG. 2B is a fragmentary isometric depthwise view showing multiple substrate layers on each of which are formed spaced-apart conductive material regions that are spatially aligned to form the substrate plate of FIG. 2A.

FIG. 3 is a fragmentary view of one of the substrate layers of FIG. 2B.

FIG. 4 is an isometric view of one of multiple prior art resistors formed by dicing and terminating the substrate plate of FIGS. 1A and 1B into discrete resistors.

FIG. 5 is an isometric view of one of multiple prior art capacitors formed by dicing and terminating the substrate plate of FIGS. 2A, 2B, and 3 into discrete capacitors.

FIG. 6 is a plan view of a ceramic substrate coated with electrically conductive material.

FIG. 7 is a pictorial drawing of a laser beam that is incident on a portion of the ceramic substrate of FIG. 6.

FIGS. 8A and 8B are, respectively, a plan view of a layer of unfired ceramic on which are formed multiple, spaced-apart conductive material regions and a side elevation view of multiple ones of the layers of FIG. 8A stacked to form a dielectric substrate containing multiple discrete capacitors.

### DETAILED DESCRIPTION OF PREFERRED EMBODIMENTS

Embodiments of the present invention construct arrays of passive electronic components, such as resistors and capacitors. The term “substrate” used in connection with passive electronic components herein refers to single layer structures as well as consolidated stack, multilayer, and laminated multi-layer structures.

Exemplary preferred embodiments of the present invention are described first with reference to the formation of an array of discrete chip resistors and then with reference to the formation of a substrate layer on which is formed an array of conductive material regions.

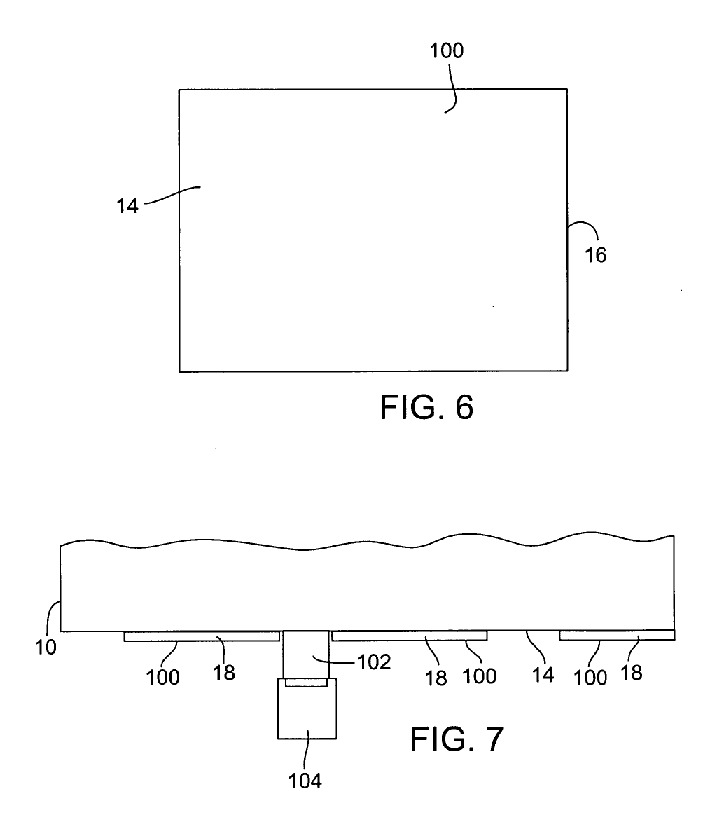

With respect to the formation of chip resistors 52, substrate 10 is preferably a fired ceramic material of 96% alumina for thick film resistors. A preferred method of forming an array of resistive material regions 32 and electrical conductor lines 18 and 20 on substrate 10 entails coating first and second major surfaces 14 and 16 of ceramic substrate 10 with an electrically conductive metal paste 100, as shown in FIG. 6.

Electrically conductive metal paste 100 is allowed to dry, and then a laser beam 102 is aligned with and directed to remove electrically conductive metal paste 100 from selected portions of each of the first and second major surfaces 14 and 16, as shown in FIG. 7. In the alternative, it may be desirable to fire metal paste 100 before patterning it with use of laser beam 102. Firing metal paste 100 before laser patterning is performed under conditions in which there would be insufficient adhesion of dried, unfired metal paste 100 to the substrate surface. The portions of electrically conductive metal paste 100 remaining on first and second major surfaces 14 and 16 of ceramic substrate 10 form electrical conductor lines 18 and 20. Electrical conductor lines 18 and 20 are arranged in spatially aligned pairs of one electrical conductor line 18 on first major surface 14 and one electrical conductor line 20 on second major surface 16 (not shown). Electrical conductor lines 18 may be segmented, as described above, or continuous. Electrical conductor lines 20 are either continuous or not present on major surface 16. The resulting electrical conductor lines 18 and 20 have an improved dimensional precision and reduced ragged edges along their side margins.

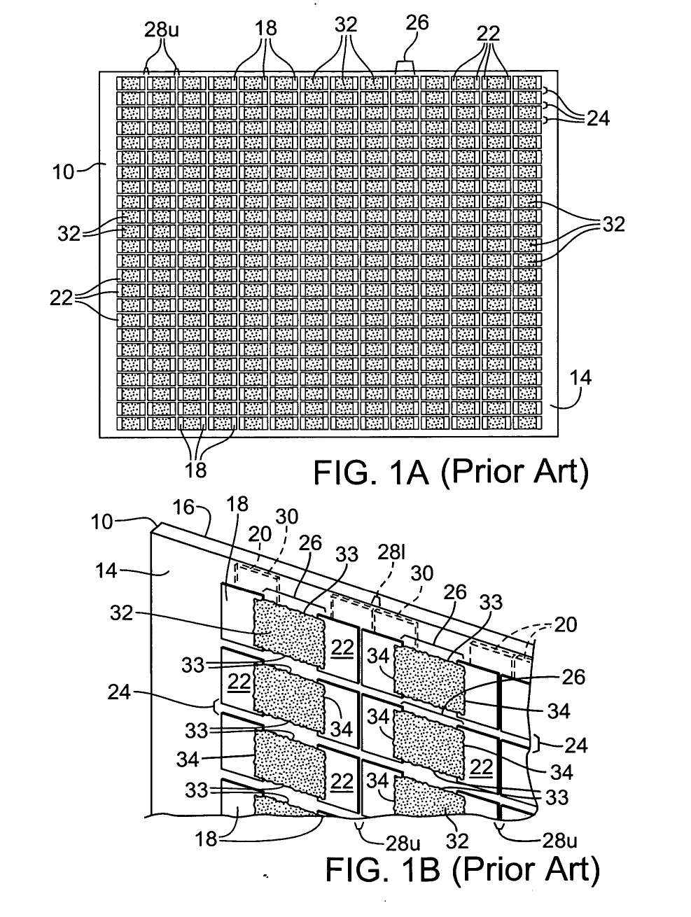

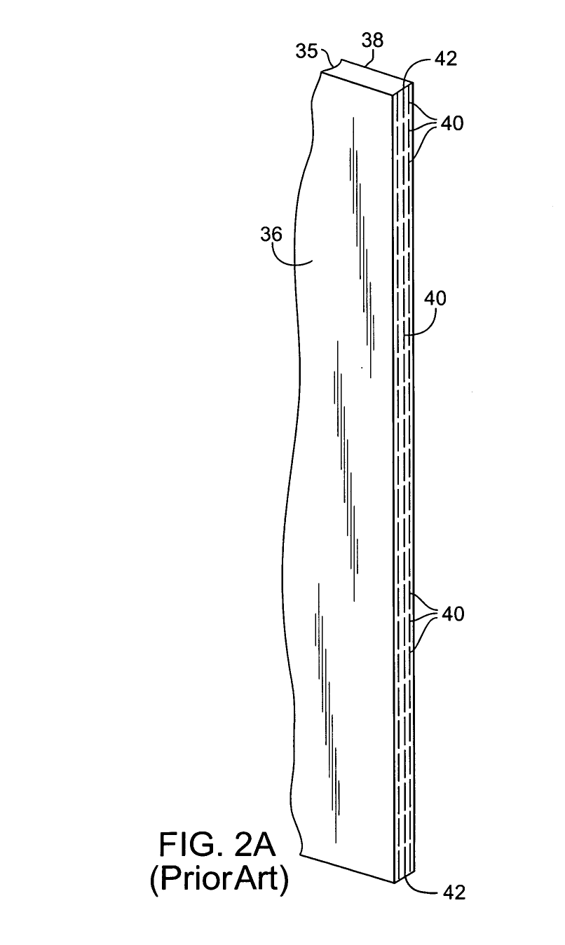

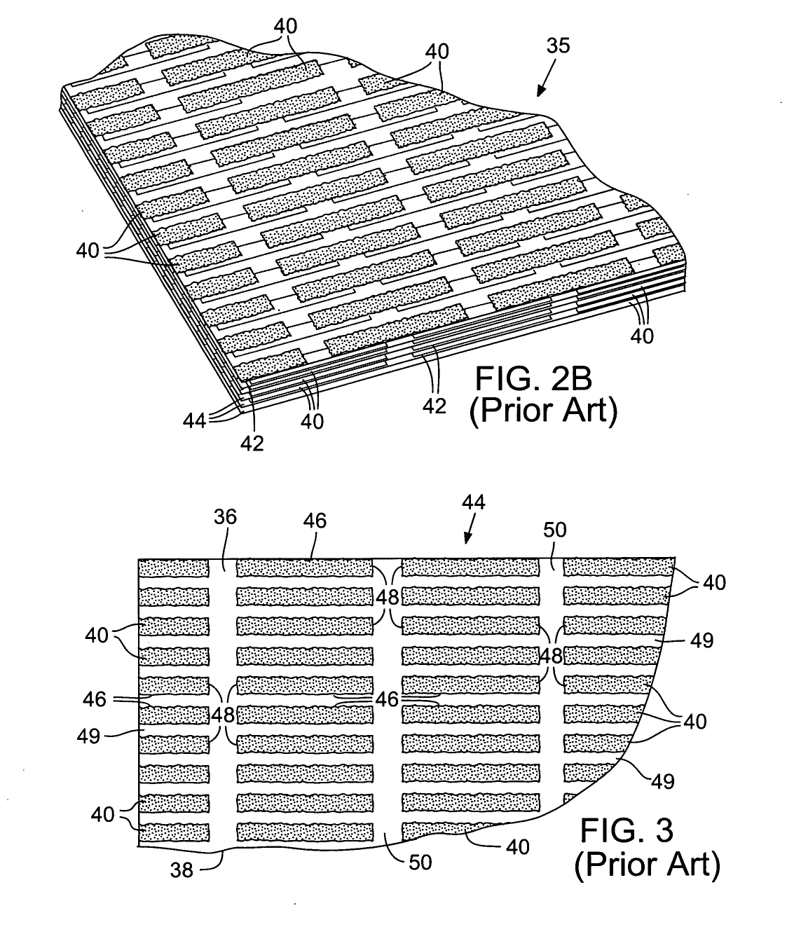

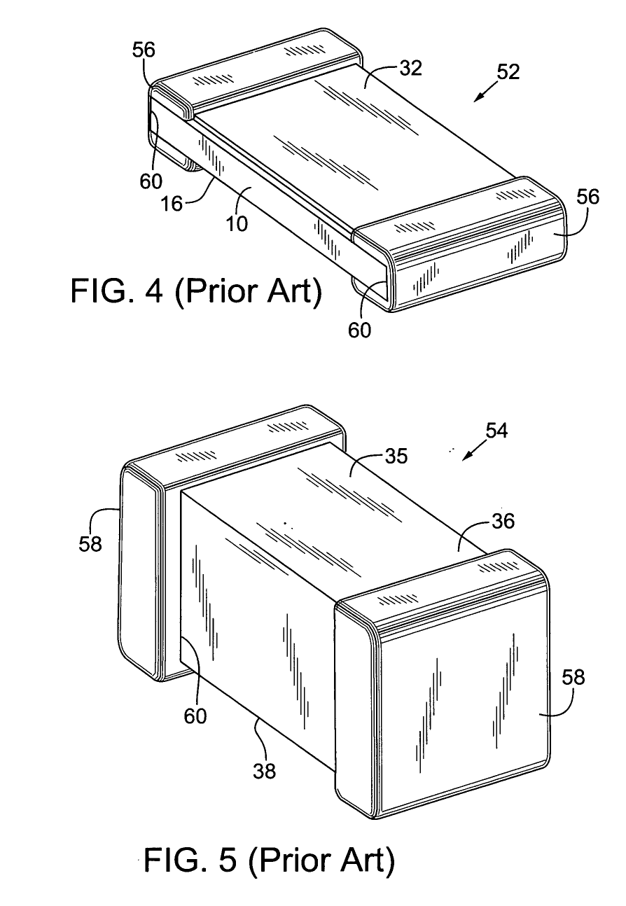

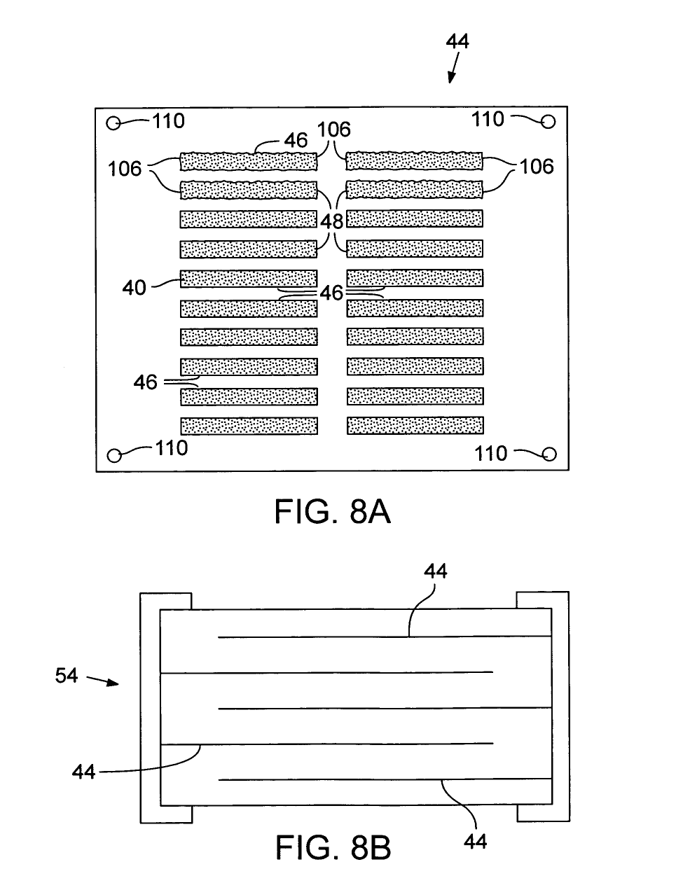

An array of multiple, mutually spaced-apart resistive material regions 32 is then formed on first major surface 14 by screen-printing a resistive material onto first major surface 14, as is known to those of skill in the art. All unfired resistive materials are laser-ablative. Depending on the sufficiency of their adhesion to first major surface 14, resistive material regions 32 may desirably be fired before laser patterning, which is described below. Each resistive material region 32 includes opposed side margins 33 and opposed end margins 34. Resistive material regions 32 are positioned such that the bulk of each resistive material region 32 lies between adjacent electrical conductor lines 18 and such that each of the opposed end margins 34 of a resistive material region 32 are positioned atop each of two adjacent electrical conductor lines 18. The use of a mechanical process, like screen-printing, which has inherent size limitations, to form microminiature, next-generation resistors including resistive material regions 32 results in the formation of ragged edges 106 on each side margin 33 and end margin 34 of each resistive material region 32 (exemplary ragged edges 106 are shown in FIGS. 1B and 8A in the four uppermost regions of conductive material). The presence of ragged edges 106 undesirably affects the dimensional precision of the array.

Next, a laser beam, preferably a UV laser beam, having a spot size and an energy distribution sufficient to ablate, or otherwise remove, the resistive material from selected regions of first and second major surfaces 14 and 16 is aligned and directed for incidence on first major surface 14 of substrate 10. Substrate 10 and the laser beam are moved relative to each other such that the laser beam removes ragged edges 106 from side and end margins 33 and 34 of resistive material regions 32. This removal is effected by directing the laser beam along at least a portion of the length of each side margin 33 and end margin 34 to effectively “clean up” the edges so that they have the desired straightness and accuracy. Following removal of ragged edges 106, a small portion of resistive material remains on each of electrode pads 22 on first major surface 14 of substrate 10, as shown in FIG. 1B.

In a preferred embodiment, the laser beam is directed along the length of each individual electrical conductor line 18 and is successively incident on each resistive material region 32 end margin 34 positioned along electrical conductor line 18 to define the overlap between resistive material region 32 and electrical conductor line 18. The laser beam is then directed in a line that is generally perpendicular to electrical conductor lines 18 such that the laser beam is incident on each resistive material region 32 side margin 33 in the line to define the space between adjacent resistive material regions 32 and the width of each region of resistive material 32.

In an alternative preferred embodiment, first major surface 14 is entirely coated with resistive material and the laser beam removes sufficient amounts of the unfired resistive material to form dimensionally precise regions of resistive material 32. Whether this preferred method is implemented depends on the cost of screen-printing the array onto substrate 10 and on the cost of resistive material and the time required to remove resistive material from the entire surface of substrate 10.

In preferred embodiments relating to the formation of an array of discrete chip capacitors 54, the substrate 44 includes unfired ceramic, such as, for example, “green” unfired ceramic tape having a thickness of about 10 microns. Further, substrate 44 may be a single layer or may include multiple layers. As shown in FIG. 8A, an array of conductive material regions 40 is formed on unfired ceramic substrate 44 by screen printing an electrically conductive metallic ink onto substrate 44, as is known to those of skill in the art. Each conductive material region 40 includes opposed side margins 46 and opposed end margins 48. The electrically conductive ink is allowed to dry following its application to unfired ceramic substrate 44.

The use of mechanical processes like screen-printing, which have inherent size limitations, to form microminiature, next-generation chip capacitors having conductive material regions 40 results in the formation of ragged edges 106 on each side margin 46 and end margin 48 of each conductive material region 40. The presence of ragged edges 106 undesirably affects the dimensional precision of the array. As is described above with reference to resistors, a preferred method of improving the dimensional precision of side and end margins 46 and 48 entails aligning and directing for incidence on unfired ceramic substrate 44 a laser beam having a spot size and an energy distribution sufficient to remove the conductive material from selected regions of first and second major surfaces 36 and 38. By moving the laser beam and unfired ceramic substrate 44 relative to each other, ragged edges 106 are ablated, or otherwise removed, from side and end margins 46 and 48 of conductive material regions 40.

The lasers used to remove the electrically conductive ink and the parameters at which these lasers are preferably operated are the same as those described above with respect to resistors. Using embodiments of this preferred method, an array of multiple, mutually spaced-apart conductive material regions can be formed such that the side and end margins of the array exhibit improved dimensional precision.

As shown in FIGS. 8A and 8B, multiple layers (e.g., 14 layers) of unfired ceramic 44, each of which carries a dimensionally precise array of conductive material regions 40, may be stacked to form a capacitor 54. Unfired ceramic layers 44 are preferably stacked such that the conductive material regions 40 on adjacent layers of unfired ceramic 44 are spatially aligned to form a dielectric material. In a preferred embodiment, the spatial alignment of adjacent unfired ceramic layers 44 is facilitated by the formation of alignment holes 110 in each ceramic substrate 44. Alignment holes 110 shown in FIG. 8 are formed in each of the four corners of each ceramic substrate 44, but may be formed in any location on ceramic substrate 44 so long as holes 110 are formed in the same exact location on each ceramic substrate 44 to be stacked. Alignment holes 110 are preferably formed using the same lasers and the same laser parameters as those described above with respect to resistors. Alternatively, alignment holes 110 may be mechanically drilled into ceramic layers 44. Alignment holes 110 may be used in conjunction with backlighting and a vision system, as is known to those of skill in the art, to facilitate precise stacking of multiple layers of unfired ceramic 44.

One major advantage conferred by preferred embodiments of the method is the ability to accurately and efficiently form an array of dimensionally precise resistors and capacitors for use as next-generation passive electronic components. Another advantage of preferred embodiments of the method above is their ability to compensate for shrinkage and warpage of the substrate and thereby permit laser ablation along nonorthogonal or not-perfectly-straight lines.

The techniques described above may similarly be applied in the fabrication of other miniature electronic components.

A preferred UV laser emits a uniform-shaped laser beam having a wavelength of less than 400 nm, and more preferably 355 nm, 266 nm, or 213 nm. (A UV laser is defined as one that emits light having a wavelength shorter than 400 nm.) A preferred laser for use in the methods described is a Q-switched, diode-pumped, solid-state UV laser that includes a solid-state lasant, such as Nd:YAG, Nd:YLF, Nd:YAP, or Nd:YVO4, or a YAG crystal doped with holmium or erbium. UV lasers are preferred because most metals and resistor materials exhibit strong absorption in the UV range; however, any laser source that generates a laser beam having a wavelength that cleanly removes organic materials may be used.

A preferred laser provides harmonically generated UV laser output of one or more laser pulses at a wavelength such as 355 nm (frequency tripled Nd:YAG), 266 nm (frequency quadrupled Nd:YAG), or 213 nm (frequency quintupled Nd:YAG) with primarily a TEM00 spatial mode profile. Laser output having a wavelength of 355 nm is especially preferred because the higher damage threshold characteristics of the second and third harmonic crystals used in, respectively, frequency doubling and frequency tripling allow for the greatest available power and pulse repetition rate. The laser preferably has a square uniform beam, the bottom area of which has a side length of between about 10 microns and about 300 microns. The laser is preferably operated at a high repetition rate of between about 15 kHz and about 100 kHz and a power level of between about 0.5 W and about 30 W. The pulse length is preferably about 30 ns, but can be any appropriate pulse length. The UV laser beam preferably has an energy per pulse of between about 50 μJ and about 1,000 μJ. The UV laser can be moved at a rate of between 10 mm/sec and 400 mm/sec, or faster, and can include either a single laser beam or multiple laser beams.

The UV laser pulses may be converted to expanded collimated pulses by a variety of well-known optical devices, including beam expander or upcollimator lens components (with, for example, a 2× beam expansion factor), that are positioned along a laser beam path. A beam positioning system typically directs collimated pulses through a beam shaping objective lens to a desired laser target position on the ceramic substrate. The beam positioning systems incorporated in Model Series Nos. 43xx and 44xx micromachining systems manufactured by Electro Scientific Industries, Inc., Portland, Oreg., the assignee of this patent application, are suitable for implementing the present invention to ablate, or otherwise remove, coatings on smaller (i.e., smaller than 10.2 cm×10.2 cm (4 in×4 in)) ceramic substrates. These systems move the square uniform laser beam over the substrate in both X and Y directions, with the substrate held in a fixed position. A moving part handler belt is normally used, however, for thin unfired green tape ceramic so that it is not transferred onto the laser system. In this case, a compound gantry beam position system is used so that the square uniform beam can be scanned in both X and Y directions over a full 300 mm (12 in×12 in) field, with the green tape held in a fixed position on the part handler belt.

It will be obvious to those having skill in the art that many changes may be made to the details of the above-described embodiments without departing from the underlying principles thereof. The scope of the present invention should, therefore, be determined only by the following exemplary claims.

1. A method of using a laser to achieve direct patterning of surface material in the fabrication of miniature electronic components, comprising:
aligning with a substrate a laser beam having a spot size and an energy distribution sufficient to remove portions of a surface material applied to the substrate; and
moving the substrate and the laser beam relative to each other to remove the portions of surface material.

2. The method of claim 1, in which the substrate is a ceramic material and the portions of surface material include mutually spaced-apart and dimensionally precise conductive material regions.

3. The method of claim 2, further comprising:
providing multiple layers of ceramic material that each carry on them the portions of mutually spaced-apart conductive material regions; and
stacking the multiple layers of ceramic material such that the conductive material regions on each layer of ceramic material are spatially aligned with conductive material regions on adjacent layers of ceramic material to thereby form a dielectric substrate in the form of an array of capacitors.

4. The method of claim 3, further comprising:
forming an alignment hole in each of the multiple layers of ceramic material; and
aligning the alignment holes formed in adjacent layers of ceramic material to facilitate spatial alignment of the multiple conductive material regions.

5. The method of claim 1, in which the substrate includes a ceramic material and the portions of surface material include multiple resistive material regions.

6. The method of claim 5, further comprising:
applying an electrically conductive metal paste to a major surface of the substrate;
aligning with the major surface a laser beam having a spot size and an energy distribution sufficient to remove selected portions of the electrically conductive metal paste from the major surface; and
imparting relative motion between the laser beam and the major surface to remove a sufficient amount of the electrically conductive metal paste to form multiple, spaced-apart electrical conductor lines on the major surface.

7. The method of claim 5, in which the ceramic material is a fired ceramic material.

8. The method of claim 5, in which the multiple resistive material regions are characterized by ragged edges, further comprising:
aligning with the ceramic substrate a laser beam having a spot size and an energy distribution sufficient to remove portions of the resistive material regions; and
moving the ceramic substrate and the laser beam relative to each other to remove the ragged edges from the side and end margins of the resistive material regions, thereby forming multiple, mutually spaced-apart resistors whose regions of resistive material have side and end margins with improved dimensional precision.

9. The method of claim 1, in which the surface material regions are formed on the substrate by screen-printing.

10. The method of claim 1, in which the laser beam is emitted by a UV laser and has a wavelength shorter than about 400 nm.

11. The method of claim 10, in which the laser beam has a wavelength selected from a group consisting essentially of about 355 nm, about 266 nm, and about 213 nm.

12. The method of claim 1, in which the spot size of the laser beam has a spot size dimension that is between about 10 microns and about 300 microns.

13. The method of claim 1, in which the laser beam has an energy per pulse of between about 50 ΦJ and about 1,000 ΦJ.

14. The method of claim 1, further comprising firing the substrate.

15. In a substrate having first and second major surfaces and carrying on one of the first and second major surfaces multiple, mutually spaced-apart regions of surface material, each of which has opposed side margins and opposed end margins that include ragged edges that undesirably affect a dimensional precision quality of the array, a method of improving the dimensional precision of the opposed side and end margins, comprising:
aligning with the substrate a laser beam having a spot size and an energy distribution sufficient to remove portions of the surface material; and
moving the substrate and the laser beam relative to each other to remove the ragged edges from the side and end margins, thereby forming multiple, mutually spaced-apart surface material regions whose side and end margins have improved dimensional precision.
